(19) United States
(12) Patent Application Publication
(10) Pub. No.: US 2026/0176006 A1
(43) Pub. Date: Jun. 25, 2026

(54) VEHICLE COMPRISING A LINEAR MOTOR LAUNCH SYSTEM POWERED BY A SUPERCAPACITOR ENERGY ACCUMULATOR

(71) Applicant: DAE, Ciboure (FR)

(72) Inventor: Thierry DEMONFORT, Ciboure (FR)

(73) Assignee: DAE, Ciboure (FR)

(21) Appl. No.: 19/127,214

(22) PCT Filed: Oct. 19, 2023
(86) PCT No.: PCT/EP2023/079172

§ 371 Date: May 5, 2025

(30) Foreign Application Priority Data
Nov. 3, 2022 (FR) FR2211467

(51) Int. Cl. B64U 10/13; B64U 10/25; B64U 50/13; B64U 50/19

(52) U.S. Cl. CPC B64U 70/70

(57) ABSTRACT

A land vehicle (12) for launching a UAV (14) with a wingspan of more than 2 metres, equipped with one or more turbojet or turboprop engines (16), is provided with a catapult system (26) for the UAV (14), comprising a launch ramp (28) and a mobile assembly (44) for supporting the UAV (14). The mobile assembly is guided by the launch ramp (28) in a launch direction (100) over a length of more than 6 metres, and preferably more than 8 metres. The catapult system (26) comprises at least one linear motor (46) comprising an inductor (48) arranged along the linear path and an armature (50) arranged on the mobile assembly (44) and at least one electrical energy accumulator with one or more supercapacitors (58) for supplying power to the linear motor (46).

### TECHNICAL SCOPE OF THE INVENTION

The invention relates to the launching of a jet-propelled or propeller-driven drone with a wingspan of two metres or more from a moving or stationary vehicle.

### PRIOR ART

Solutions for launching UAVs from stationary or moving ground vehicles are known. The UAVs in question generally have a small wingspan and low mass, as illustrated for example in document U.S. Pat. No. 7,665,691, which proposes launching a light UAV from a moving vehicle with or without catapulting, or document CN106394924, which describes a land vehicle equipped with a UAV catapulting system, having a launch ramp, a carriage movable on this ramp, the carriage carrying the drone, and a linear motor having stator windings arranged on the carriage and permanent magnets arranged along the ramp, for launching the carriage very gradually. To power the windings, which move along the launch ramp with the carriage, from an electrical power supply on the vehicle, it is necessary to provide electrical rails along the launch ramp and brushes or current collectors on the carriage carrying the drone. Document CN112173153 discloses a land vehicle for launching small UA Vs in bursts and provided with the same catapulting system as document CN106394924, powered by an electrical energy accumulator with one or more supercapacitors for the electrical power supply to the linear motor. However, this device is not suitable for launching heavy UAVs. These devices are neither designed nor adapted for launching heavy UAVs.

In order to propose means of launching a drone with a large wingspan and/or high mass from the ground, with the aim of carrying out a mission in particular of reconnaissance or of dropping a load, the load being able in particular to comprise rescue equipment, foodstuffs, ammunition, transmission means, weapons or a machine, rapidly and at a distance from the launch zone, it was proposed in document WO2020254512A1 an assembly comprising a launch motor vehicle and a drone, the automobile launch vehicle being capable of rolling along a launch track to exceed a given speed threshold with respect to a surrounding mass of air, the automobile launch vehicle being provided with a launch ramp cooperating with the drone in order, in a launch position, to guide the drone in translation from a starting position in a launch direction towards the front of the automobile launch vehicle, the drone comprising one or more engines and not comprising landing gear. The launch ramp can be equipped with an energy accumulator capable of impulsively releasing previously accumulated energy to catapult the UAV. The energy accumulator can be sized to enable take-off, in combination with the maximum thrust of the engines and the speed of the vehicle. It can also be dimensioned to enable take-off in combination with the maximum thrust of the engines with the vehicle stationary. This energy accumulator comprises one or more pneumatic energy accumulators, consisting of tanks of pressurised gas, in particular compressed air, the expansion of which in free air or in a variable-volume chamber of a pneumatic actuator generates mechanical work for catapulting the UAV. However, this type of energy accumulator has its limits in terms of power, particularly because of the space required.

Larger UAVs are usually catapulted from the ground. They are most often launched using pneumatic catapult systems operating on very long launch rails fixed to the ground. Setting up these launch systems is extremely time-consuming, requiring heavy logistics and a considerable number of operators. The launch system installed and fixed to the ground cannot be moved quickly to another launch zone. This requires complete dismantling of the installations, which runs counter to the criteria of mobility and speed of intervention sought by defence or civil security units. What's more, these systems cannot be quickly repositioned upwind when the weather changes on the ground.

### DESCRIPTION OF THE INVENTION

The aim of the invention is to remedy the disadvantages of the prior art and to propose means of launching a drone with a large wingspan and/or high mass from the ground, in particular in order to carry out a reconnaissance mission or to drop a payload, wherein the payload may include rescue equipment, foodstuffs, ammunition, transmission or optronic means, weapons and explosives, tactical neutralisation systems, mini-UAVs or robots, whatever their use, on land or at sea, rapidly and at a distance from the launch zone.

To this end, according to a first aspect of the invention, a land vehicle is proposed for launching a drone according to claim 1.

The use of one or more supercapacitors enables electrical energy to be stored with a high power density and an energy density adapted to the application, thus satisfying the constraints of catapulting from a vehicle. The accumulated electrical energy is released with a very low time constant, enabling the drone to accelerate rapidly throughout the catapulting phase, which in practice is of the order of half a second.

By opting for a permanent magnet synchronous motor, with a stator inductor made up of AC-powered windings or electromagnets and an armature made up of permanent magnets, a non-powered armature is provided, which avoids the need for a current collector between the launch ramp and the mobile assembly.

In one embodiment, the electrical energy accumulator with one or more supercapacitors has an electrical capacity greater than 10 F, preferably greater than 15 F, and a nominal voltage greater than 500 V, preferably greater than 600 V, more preferably greater than 700 V, and more preferably greater than 750 V.

This type of design allows electrical energy of over 1 MJ to be stored. In practice, only a fraction of this stored energy, approximately ⅓, is restored during the catapulting phase, and high values of electrical capacity, greater than 15 F, and nominal voltage, greater than 700 V, are preferred. Nominal voltage means here the maximum voltage that the energy accumulator with one or more supercapacitors can permanently withstand.

Power electronics are required to supply the linear motor with alternating current and to control the inductor. According to various embodiments:
the linear motor is connected to the electrical energy accumulator with one or more supercapacitors via an inverter; and/or
the inductor is controlled by a circuit of power switches.

It is of course necessary to charge the energy accumulator, and charging equipment is preferably provided on board the vehicle. To this end, the catapult system preferably comprises a circuit for charging the electrical energy accumulator with one or more supercapacitors, comprising one or more primary sources of electrical energy. According to various embodiments, which may be combined:
the one or more primary sources electrical energy comprise(s) at least one primary DC source of electrical energy, for example a DC generator, a battery or a fuel cell; and/or
the one or more primary sources electrical energy comprise(s) at least one primary source of alternating current electrical energy, for example an alternating current generator, connected to the electrical energy accumulator with one or more supercapacitors by a rectifier; and/or
the one or more primary sources electrical energy are capable of delivering a power greater than 5 kW; and/or
the power supply circuit of the electrical energy accumulator with one or more supercapacitors is connected to photovoltaic panels carried by the vehicle; and/or
The catapult system includes a regenerative braking system for the mobile assembly, electrically connected to the electrical energy accumulator with supercapacitors, capable of transforming the kinetic energy of the mobile assembly into electrical energy transmitted to the electrical energy accumulator with supercapacitors.

In practice, it is envisaged that at the end of an acceleration phase of the mobile assembly carrying the drone on a first portion of the launch ramp, the drone separates from the mobile assembly which still has to be braked in order to stop at the end of the launch ramp at the latest. The mass of the mobile assembly is high due to the presence of the armature. According to one embodiment, the catapulting system therefore comprises at least one, and preferably at least two, devices for braking the mobile assembly from among the following devices:
an electromagnetic braking device, preferably an eddy current braking device, disposed in a front end portion of the launch ramp;
a spring-loaded kinetic energy storage device;
a device for absorbing impact energy using elastomer pads;
a fluidic reversible energy absorption device;
a friction braking device.

According to an embodiment, the launch ramp in the launch position has a front end portion which projects from a front end of the vehicle body, and the vehicle is equipped with a removable front balancing running gear, movable between a storage position and an operational position, the removable front balancing running gear in the operational position having wheels located less than 50 cm from the ground, at a distance in front of the front end of the body, for example more than 1 metre in front of the front end of the body, preferably under the front end portion of the launch ramp. The main purpose of this front balancing gear is to prevent the vehicle from tilting forward when braking the mobile assembly after the drone has taken off, when the mobile assembly reaches the front end of the launch ramp. The front balance gear can be fitted with an active suspension.

In a similar way, it can be provided that the launch ramp in the launch position has a rear end portion which projects beyond a rear end of the body of the vehicle, and that the vehicle is equipped with a removable rear balancing running gear, movable between a storage position and an operational position, the removable rear balancing running gear in the operational position having wheels located less than 50 cm from the ground, behind a rear end of the body of the vehicle, preferably under the rear end portion of the launch ramp. This rear running gear enables the vehicle to be balanced during the acceleration phase of the UAV and the mobile assembly, before take-off. The rear balancing gear can be fitted with an active suspension.

Preferably, the vehicle is able to move by rolling with the UAV catapult system in the launch position. According to one embodiment, this makes it possible in particular to envisage a launch mode in which the vehicle is moving in a straight line facing the wind, at a speed exceeding a given speed threshold in relation to the wind at the time of catapulting the UAV. When the terrain is suitable, launching from the moving vehicle helps to limit the energy that has to be consumed by the UAV in the take-off phase. The relative speed obtained by the moving vehicle is added to the propulsion speed of the launcher and makes it easier to obtain the lift speed of the UAV at the ramp exit. This is all the more necessary when the length of the ramp is short and the mass of the UAV is high.

But the ability to move into the launch position is also useful if the launch is always carried out from a standstill: in this case, it enables the launch ramp to be positioned or repositioned in an ideal launch position, facing into the wind, just a few moments before launch.

The vehicle is preferably motorised. If necessary, it may comprise a motorised vehicle towing a trailer or semi-trailer. Preferably, it is a wheeled vehicle, preferably with a double rear axle, to ensure that the forces generated when the drone is launched are absorbed. The vehicle is preferably an all-terrain motor vehicle, with the ramp positioned, for example, on the roof of the vehicle or on a platform provided for this purpose. If necessary, an all-terrain vehicle can be launched from rough terrain or an unprepared runway, for example from a beach in the case of a sea rescue. Preferably, an active suspension incorporating attitude correction is arranged between a chassis and the vehicle's wheel sets, or between the launch ramp and the chassis of the motor vehicle, or between the mobile assembly and the launch ramp, to help stabilise the UAV.

In one embodiment, the vehicle has at least two, and preferably at least three, stabilisers that can be moved between a retracted position and an operational position resting on the ground. Such stabilisers may be used to correct the attitude of the vehicle when stationary before launch. They can also define a larger polygon for supporting the vehicle on the ground than that defined by the vehicle's wheels. They can be operated hydraulically, pneumatically or electrically.

In practice, it is desirable for the vehicle to have dimensions that do not affect its manoeuvrability. Preferably, therefore, the launch ramp can be retracted or folded into a transport position. It can be moved into the transport position by means of a telescopic movement. Preferably, however, the launch ramp comprises several articulated sections, at least some of which are movable between the launch position, in which the sections are aligned, and a transport position, in which the sections are side by side. The sections that are adjacent in the launch position are linked in pairs by joints, which preferably have a single pivot axis. If the launch ramp comprises more than two sections, the pivot axes between adjacent sections are preferably parallel to each other. In the transport position, the pivot axes are preferably located in a vertical plane. In a preferred embodiment, the hinge axis or axes are vertical in the transport position. This minimises the force required to deploy the launch ramp from the transport position to the launch position.

The articulated sections of the launch ramp can preferably form a linear path for the mobile assembly with a length of at least six metres, preferably at least eight metres and at most fourteen metres. However, to enable heavier UAVs to be launched, or in less favourable conditions where the length of the articulated ramp is not sufficient, it may be possible, where appropriate, to add additional launch ramp sections, possibly carried on a vehicle trailer or independently, to the articulated sections in order to lengthen the launch ramp, which may then exceed 14 metres in length. Of course, such a ramp can only be used when the vehicle is stationary, and with supports on the ground.

Preferably, the vehicle offers, in a modular fashion, several of the launch modes envisaged above:
a launch mode with the vehicle in motion, and/or
a launch mode with the vehicle stationary but able to move into the launch position, and/or
a launch mode with the vehicle stationary, balanced by stabilisers, and/or
a launch mode with a ramp extended by additional sections requiring independent ground support.

This modularity is particularly interesting for the user, enabling him to adapt the vehicle to the launch conditions encountered in the field.

In the event that the UAV is jet-propelled, it is advantageously provided, in order to protect the inductor disposed along the launch ramp, that the mobile assembly is provided with a thermal deflector for protecting a portion of the launch ramp situated behind the mobile assembly with reference to the direction of launch. The deflector is shaped to deflect a jet of air expelled by the drone's jet engine(s), in order to avoid damaging the rail incorporating the electromagnetic and braking systems and, more generally, the vehicle and its occupants. If the vehicle is intended to launch jet-powered drones and turboprop drones, the deflector can be removable.

In one embodiment, the mobile assembly comprises a carriage running on the launch pad. The mobile assembly and the launch ramp can also be equipped with an electromagnetic levitation circuit for the mobile assembly relative to the launch ramp.

Another aspect of the invention relates to an assembly comprising a vehicle as described above and a UAV with a wingspan of more than two metres equipped with one or more turbojet or turboprop engines, supported by the mobile assembly.

According to one embodiment, the assembly also comprises at least one locking mechanism, movable between a locking position for fixing the drone relative to the mobile assembly in an armed position, and an unlocking position allowing movement of the drone relative to the mobile assembly. In particular, the attachment device can be provided with a trigger, preferably mechanical, electromechanical or pyrotechnical, preferably controlled so as to be triggered when the UAV reaches a given position on the launch ramp, corresponding to the end of the linear motor.

The UAV can be controlled during the take-off phase from the vehicle, in a pre-programmed way using dedicated avionics equipment, or independently by a remote operator.

Preferably, dropping the load involves turning the drone onto its back, then, by gravity, removing the load from a cavity in the drone flying on its back, then, preferably, deploying a parachute to slow down the load in free fall.

Another aspect of the invention, which may be combined with the preceding aspect of the invention, relates to a land launch vehicle suitable for launching a UAV with a wingspan of more than two metres equipped with one or more engines, the land launch vehicle being provided with a catapult system comprising a launch ramp and a mobile assembly guided by the launch ramp along a linear path of the launch ramp, the mobile assembly being capable of supporting the drone oriented in a launch direction, characterised in that the mobile assembly is provided with a thermal deflector for protecting a portion of the launch ramp located behind the carriage with reference to the launch direction of the drone. Such a deflector is particularly useful when the catapult system incorporates a linear motor, which the thermal deflector then makes it possible to protect from the flow of hot air coming from the jet engine or engines.

According to another aspect of the invention, which can be taken in combination with the preceding aspects of the invention, the invention relates to a land launch vehicle for launching a UAV with a wingspan greater than 2 metres equipped with one or more engines, the land launch vehicle comprising a body and being provided with a catapult system comprising a launch ramp which, in a launch position, has a front end portion which projects beyond a front end of the body of the vehicle, characterised in that the vehicle is equipped with a removable balancing running gear which is movable between a storage position and a launch position, the balancing running gear in the launch position being on the ground, at a distance in front of the front end of the body, preferably under the front end portion of the launch ramp.

### BRIEF DESCRIPTION OF THE FIGURES

Other features and advantages of the invention will become apparent from the following description, with reference to the attached figures, which illustrate:

In FIG. 1, an isometric view taken from three quarters rear right of an assembly according to a first embodiment of the invention, comprising a motor vehicle equipped with an electromagnetic catapult system and a UAV, in a transport position;

In FIG. 2, a side view of the assembly as shown in FIG. 1, in the transport position;

In FIG. 3, a top view of the assembly shown in FIG. 1, illustrating the deployment of a catapult system in the drone launch position;

FIG. 4, a side view of the assembly as shown in FIG. 1, in a launch position, before the drone is launched;

FIG. 5, a side view of the assembly as shown in FIG. 1, in a launch, during the launch of the UAV;

In FIG. 6, a side view of a variant of the assembly shown in FIG. 1, in a launch position;

In FIG. 7, an electrical diagram of the catapult system of the assembly shown in FIG. 1.

### DETAILED DESCRIPTION OF REALISATION METHODS

FIGS. 1 and 2 show, in a transport position, an assembly 10 comprising a land vehicle 12 and a UAV 14 equipped here with two turbojet engines 16, supported by the vehicle 12.

The UAV 14 illustrated is just one example of a class of UAVs intended to be transported and launched using the vehicle 12, and which is made up of UAVs with one or more turbojets or turboprop engines having a fuselage 18 and a wing 20 which, in flight, has a wide wingspan, in particular greater than 2 metres or 2.5 metres, or even greater than 3 metres, possibly with variable geometry, for example with foldable wings, so that the width of the wing for transport is narrower than for launch and flight. UAV 14 has a relatively high take-off weight, for example greater than 350 kg. The UAV 14 is preferably without landing gear, which reduces the empty weight and volume of the UAV and significantly reduces drag, and also helps to increase the payload and range. In addition, the absence of landing gear simplifies the mechanics, reducing the risk of failure.

The vehicle 12 shown here is a wheeled all-terrain motor vehicle, with a front wheel set 22 and, preferably, a double rear axle 24 to increase the payload and, as will be seen later, take up the forces when launching the UAV 14 from the vehicle 12.

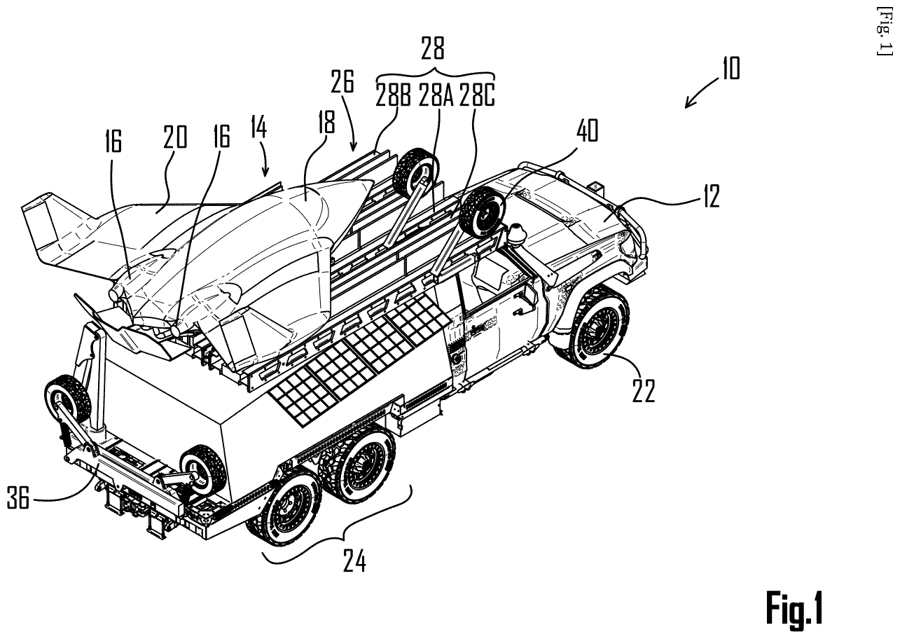

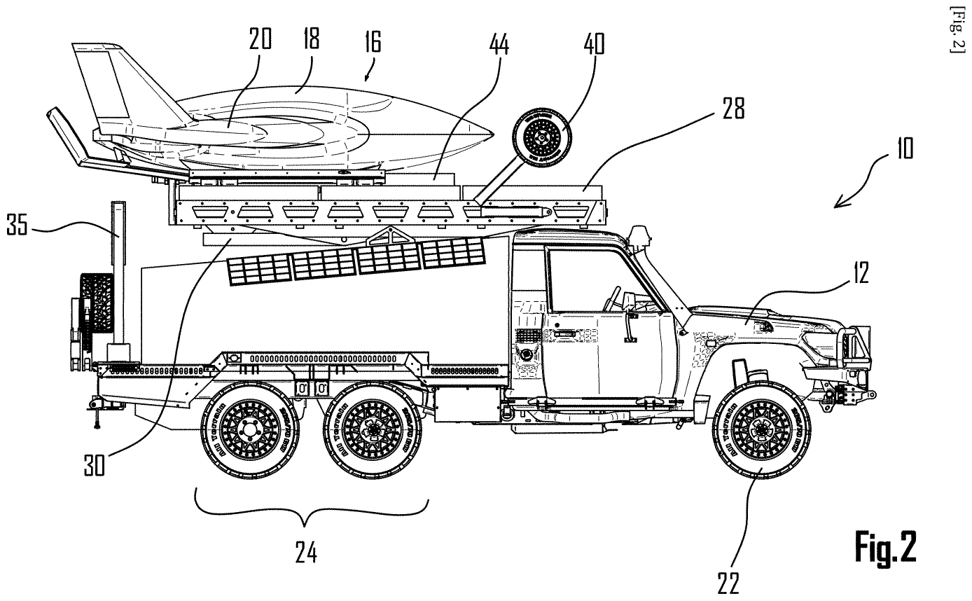

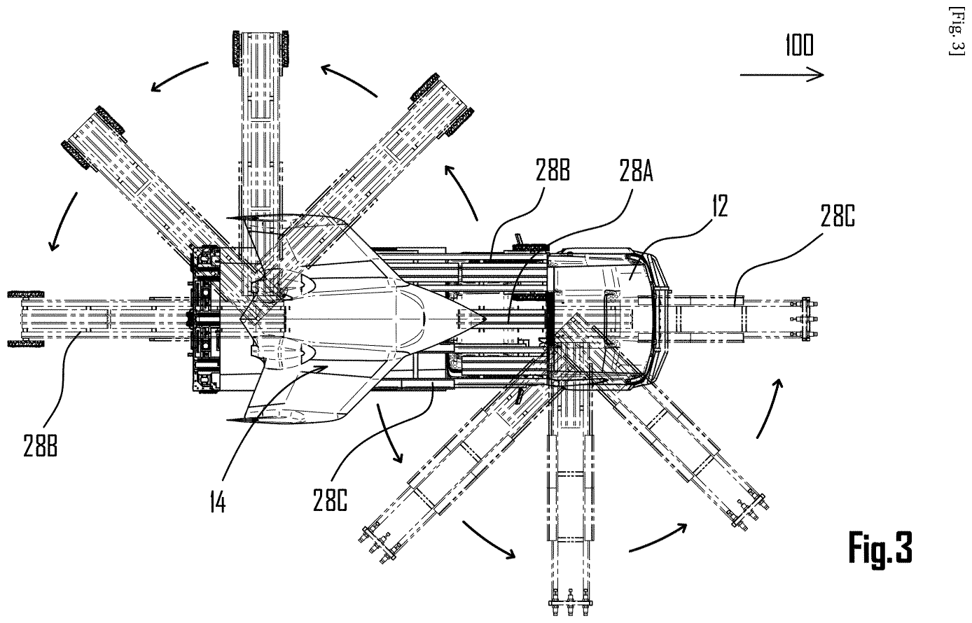

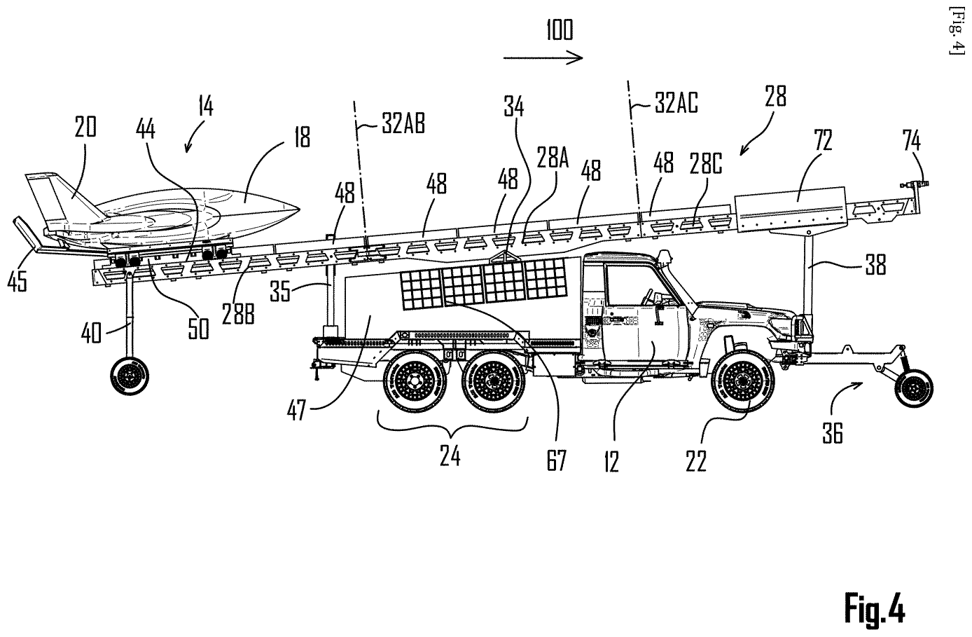

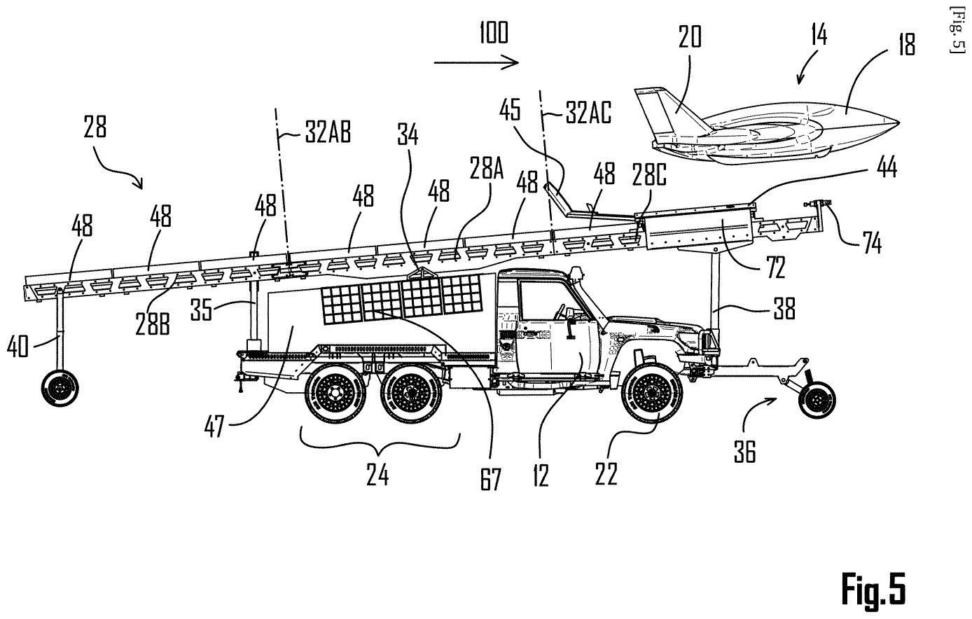

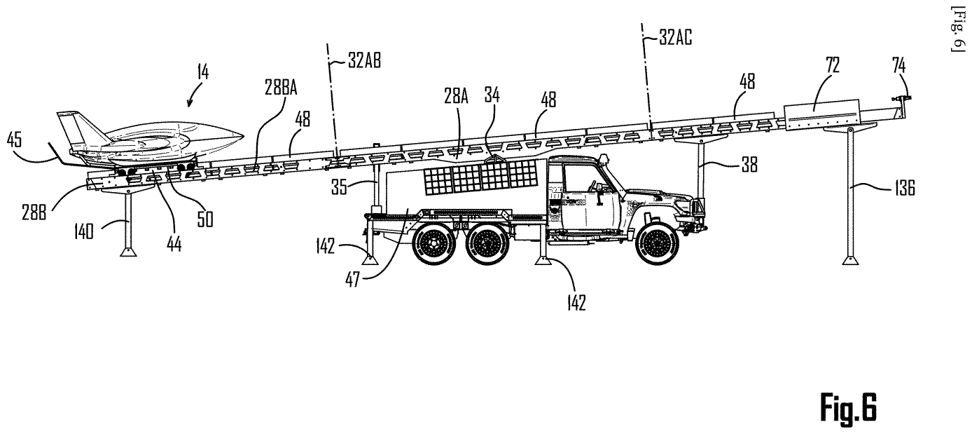

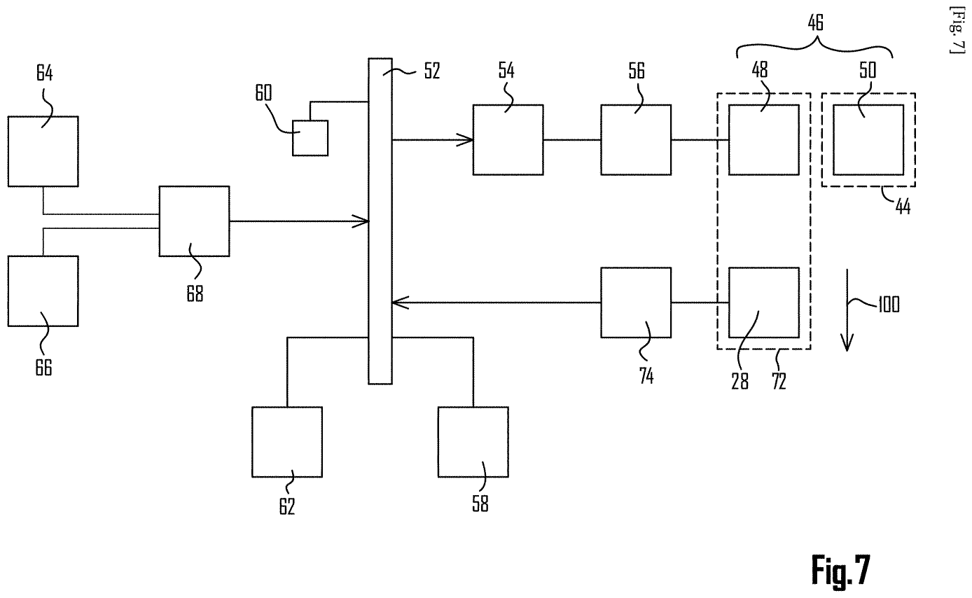

The vehicle 12 is equipped with a system 26 for catapulting the UAV 14, comprising a launch ramp 28 resting on a platform, illustrated in the transport position in FIGS. 1 and 2, during deployment in FIG. 3, and in a launch position in FIGS. 4 and 5. The launch ramp 28 comprises several sections, articulated in pairs, more specifically a central section 28A, a rear section 28B articulated at a rear end of the central section 28A and a front section 28C articulated at a front end of the central section 28C. In the transport position, the sections 28A, 28B and 28C are positioned side by side on a support plate 30. By unfolding the rear section 28B and the front section 28C, as shown in FIG. 3, the launch ramp is brought into the launch position shown in FIG. 4. The pivot axes 32AB, 32AC of the articulations between the central section 28A and the rear section 28B on the one hand and between the central section 28A and the front section 28C on the other hand, are parallel to each other and, preferably, vertical in the transport position and during deployment, to limit the deployment forces. If necessary, deployment may include a final phase of pivoting the platform 30 and the unfolded ramp about a transverse horizontal pivot axis 34, using a crane 35, so that the ramp 28 in the launch position is more inclined than its sections 28A, 28B, 28C in the transport position, which are preferably horizontal.

In the launch position illustrated in FIG. 4, the launch ramp 28 has a front end portion which protrudes from a front end of the vehicle body, and the vehicle is preferably equipped with a removable front balancing running gear 36, movable between a storage position at the rear of the vehicle (FIG. 1) and an operational position (FIG. 4), the front balancing running gear 36 in the operational position having wheels located less than 50 cm from the ground, at a distance in front of the front end of the vehicle body, for example more than 1 metre in front of the front end of the body, preferably under the front end portion of the launch ramp 28. A front support arm 38 connects a front portion of the launch ramp 28 to a front end of the body of the vehicle 12, at a point located longitudinally between the front wheel train 22 of the vehicle 12 and the removable front balancing wheel train 36.

Similarly, the launch ramp 28 in the launch position has a rear end portion that projects from a rear end of the body of the vehicle 12, and the vehicle 12 is preferably equipped with a removable rear balancing running gear 40, movable with the rear section 28B of the launch ramp 28 between a storage position (in FIG. 1) and an operational position (in FIG. 4), the removable rear balancing running gear 40 in the operational position having wheels located less than 50 cm from the ground, behind a rear end of the body of the vehicle 12, preferably under the rear end portion of the launch ramp 28.

The deployment of the sections 28B, 28C of the launch ramp illustrated in FIG. 3 takes place when the vehicle is stationary but, remarkably, the vehicle 12 is capable of travelling with the catapult system 26 of the UAV 14 in the launch position shown in FIG. 4.

If necessary, the launch ramp 28 can be lengthened further with additional sections which are interposed between the central section 28A and one and/or other of the front end section 28C and the rear end section 28B. The additional sections can be transported in a trailer or an accompanying vehicle. The assembly operations for deploying the ramp are then more extensive, and the vehicle is no longer able to travel with the extended launch ramp deployed.

Alternatively, it is possible, according to the variant illustrated in FIG. 6, to retain the three-section structure 28A, 28B, 28C, by enlarging each of the sections. In this case, removable feet 136, 140 resting on the ground are provided instead of the removable balancing trains 36, 40. There are also removable stabilisers 142 which rest on the ground to fix the vehicle 12 in the position shown in FIG. 6.

The launch ramp 28 defines a launch direction located in a median vertical longitudinal plane of the vehicle and a linear path with a length of more than 6 metres, and preferably more than 8 metres in the launch position of FIG. 5, and which can exceed 14 metres in the launch position of FIG. 6, for a mobile assembly 44 supporting the UAV 12.

This mobile assembly 44 is here constituted by a carriage rolling in the slides of the launch ramp 28, but it is envisaged as an alternative to equip the mobile assembly 44 and the launch ramp with a circuit for the electromagnetic levitation of the mobile assembly 44 with respect to the launch ramp 28. The mobile assembly 44 is provided with a thermal deflector 45 to protect a portion of the launch ramp located behind the mobile assembly 44 with reference to the direction of launch.

The catapult system 26 used to launch the UAV 12 comprises a linear motor 46 comprising an inductor 48 arranged along the linear path and an armature 50 arranged on the mobile assembly 26, as shown in FIG. 7. The linear motor 46 is preferably a synchronous motor whose armature 50 is composed of permanent magnets or electromagnets and the inductor 48 comprises electromagnets or windings. More specifically, the inductor 48 of the linear motor 46 extends from the rear end of the launch ramp 28 forwards over only a portion of the launch ramp, named the acceleration portion. A portion of the launch ramp 28, named braking portion, located at the front end of the launch ramp, is reserved for braking the mobile assembly after the UAV has been launched.

The linear motor 46 is powered by a supply circuit illustrated in FIG. 7 and preferably housed in a compartment 47 of the vehicle 12. The field 48 of the linear motor 46 is connected to a DC bus 52 via an inverter 54 and a control power switch circuit 56. Remarkably, this DC bus 52 is supplied electrically by an electrical energy accumulator with one or more supercapacitors 58. The electrical energy accumulator with one or more supercapacitors 58 has an electrical capacity greater than 10 F, preferably greater than 15 F, and a nominal voltage greater than 500 V, and preferably greater than 600 V, and preferably greater than 700 V, and preferably greater than 750 V. The DC bus 52 can advantageously be connected to a low-pass filter 60 to limit transient overvoltage and to a discharge circuit 62 to enable the supercapacitors to be discharged if necessary.

The linear motor power supply circuit also includes a circuit for charging the electrical energy accumulator 58 to one or more supercapacitors, including one or more primary electrical energy sources 64, 66 capable of delivering a power preferably greater than 5 kW, which may include in particular:
a primary source of DC electrical energy, for example a DC generator, battery or fuel cell; and/or
a primary source of alternating current electrical energy, for example an alternating current generator;

These primary sources of electrical energy are preferably carried by the vehicle and may, if necessary, be supplemented by:
a photovoltaic generator 67 carried by the vehicle and/or
a regenerative braking system for the mobile assembly 72, 74 electrically connected to the charging circuit, capable of transforming the kinetic energy of the mobile assembly 44 into electrical energy transmitted to the charging circuit.

The primary electrical energy source(s) 64, 66 are preferably connected to the DC bus 52 and the supercapacitor electrical energy store 58 by an adapter circuit 68, which may include, for example, a rectifier or a DC voltage booster.

The braking portion of the launch ramp, located at the front end of the launch ramp, is equipped with at least one, and preferably at least two, braking devices 70 for the mobile assembly from among the following devices:
an electromagnetic braking device 72, preferably eddy current braking;
a device for absorbing impact energy using elastomer pads 74;
a fluidic reversible energy absorption device;
a friction braking device.

If necessary, the electromagnetic braking device 72 can be connected to the DC bus by an energy converter 74 including a rectifier, to form a regenerative braking circuit. Naturally, the examples shown in the figures and discussed above are for illustrative and non-limiting purposes only. It is explicitly envisaged that the various illustrated embodiments may be combined with one another in order to propose other embodiments.

To lift off the UAV 14 from the launch position shown in FIG. 4, the turbojet or turboprop engines are powered and brought to maximum thrust, while the UAV 14 is held fixed to the mobile assembly 44 by a first locking system and the mobile assembly 44 is held fixed relative to the launch ramp 28 by a second locking system. With the supercapacitor energy accumulator 58 charged, a sudden discharge is controlled in the inductor 48, via the inverter 54 and the power switch circuit 56. The linear motor is preferably controlled so as to produce a constant force on the armature 50 and the mobile assembly 44 throughout the launch and take-off phase, over a length which may be of the order of 6 metres for an 8-metre launch ramp, or 8 metres for a 10-metre launch ramp. The lock between the mobile assembly 44 and the launch ramp 28 is released, and the mobile assembly undergoes an acceleration proportional to the resulting electromagnetic force on the armature 50 and to the thrust of the turbojet engines 16 or turboprop engines. The lock between the mobile assembly 44 and the UAV 14 is released as soon as the UAV 16 reaches a speed relative to the surrounding air mass sufficient to ensure the lift of the UAV 16, which separates from the mobile assembly 14 at the latest when the mobile assembly enters the front end portion of the ramp 28 which includes the braking device(s) for the mobile assembly 44. Finally, and as illustrated in FIG. 5, the moving assembly 44, whose mass is nevertheless significant since it includes the mass of the armature 50, is slowed and stopped by the various braking devices, and in particular by the electromagnetic brake 72 and the shock absorber 74. The whole of this procedure for taking off the UAV 14 can be carried out while the land vehicle 12 is stationary or, preferably, while the land vehicle 12 is travelling in a straight line at a regulated speed, which makes it possible to reach the desired relative speed of the UAV 14 with respect to the mass of air more quickly.

From the launch position in FIG. 6, the take-off procedure is similar, but naturally with the vehicle 12 stationary.

Various modifications are envisaged. The linear motor 46 can be an asynchronous machine. The launch ramp deployment mechanism can be telescopic. The vehicle 12 can be a trailer or semi-trailer, or an articulated vehicle consisting of a tractor and a trailer or semi-trailer. It can also be a tracked vehicle.

1. A land vehicle for launching a drone equipped with one or more turbojet or turboprop engines, the land vehicle being provided with a catapult system for the drone, comprising a launch ramp and a mobile assembly for supporting the drone, the mobile assembly being, in a launch position of the catapult system, guided by the launch ramp in a launch direction along a linear path of the launch ramp, the catapult system comprising at least
a permanent magnet synchronous linear motor comprising an inductor consisting of windings or electromagnets supplied with alternating current, and an armature consisting of permanent magnets, and
at least one electrical energy accumulator with one or more supercapacitors for supplying power to the linear motor,
wherein the launch ramp has a length of more than 8 meters, the inductor being stator-shaped, the windings or electromagnets of the inductor being disposed along the linear path and the permanent magnets of the armature being disposed on the mobile assembly.

2. The land vehicle of claim 1, wherein the electrical energy accumulator with one or more supercapacitors has an electrical capacity greater than 10 F, and a nominal voltage greater than 500V.

3. The land vehicle of claim 1, wherein:
the linear motor is connected to the electrical energy accumulator with one or more supercapacitors via an inverter; and/or
the inductor is controlled by a power switch circuit.

4. The land vehicle of claim 1, wherein the catapult system comprises a circuit for charging the electrical energy accumulator with one or more supercapacitors, comprising one or more primary sources of electrical energy.

5. The land vehicle of claim 4, wherein:
the one or more primary sources electrical energy comprise at least one primary DC electrical energy source, for example a DC generator, a battery or a fuel cell; and/or
the one or more primary sources electrical energy comprise at least one primary source of alternating current electrical energy, for example an alternating current generator, connected to the electrical energy accumulator with one or more supercapacitors via a rectifier; and/or
the one or more primary sources electrical energy are capable of delivering a power greater than 5 kW; and/or
an electrical power supply circuit of the electrical energy accumulator with one or more supercapacitors is connected to photovoltaic panels carried by the land vehicle; and/or
the catapult system comprises a regenerative braking system for the mobile assembly, electrically connected to the electrical energy accumulator with supercapacitors, capable of transforming kinetic energy of the mobile assembly into electrical energy transmitted to the electrical energy accumulator with supercapacitors.

6. The land vehicle of claim 1, wherein the catapult system comprises one or more devices for braking the mobile assembly from among the following devices:
an electromagnetic braking device or an eddy current braking device, disposed in a front end portion of the launch ramp;
spring-loaded kinetic energy storage device;
a device for absorbing impact energy using elastomer pads;
a fluidic reversible energy absorption device;
a friction braking device.

7. The land vehicle of claim 1, wherein the launch ramp in a launch position has a front end portion which protrudes from a front end of a vehicle body of the land vehicle, and the land vehicle is equipped with a removable front balancing running gear, movable between a storage position and an operating position, the removable front balancing running gear in the operating position having wheels located less than 50 cm from the ground, at a distance in front of the front end of the body.

8. The land vehicle of claim 1, wherein the launch ramp in a launch position has a rear end portion which protrudes from a rear end of a vehicle body of the land vehicle, and the land vehicle is equipped with a removable rear balancing running gear, movable between a storage position and an operating position, the removable rear balancing running gear in the operating position having wheels located less than 50 cm from ground, behind a rear end of the vehicle body.

9. The land vehicle of claim 1, wherein the land vehicle is able to move by rolling with the catapult system of the drone in a launch position.

10. The land vehicle of claim 1, wherein the land vehicle comprises at least two stabilisers movable between a retracted position and an operational position resting on ground.

11. (canceled)

12. The land vehicle of claim 1, wherein the mobile assembly is provided with a thermal deflector for protecting a portion of the launch ramp located behind the mobile assembly with reference to the launch direction.

13. The land vehicle of claim 1, wherein:
the mobile assembly comprises a carriage rolling on the launch ramp, and/or
the mobile assembly and a launch pad are equipped with a circuit for electromagnetically levitating the mobile assembly relative to the launch pad.

14. Compound vehicle comprising the land vehicle of claim 1, and a UAV with a wingspan of more than 2 meters, equipped with one or more turbojet engines or turboprop engines, supported by the mobile assembly.

15. The compound vehicle of claim 14, wherein the UAV has a take-off weight of more than 350 kg.

16. The land vehicle of claim 2, wherein the electrical energy accumulator with one or more supercapacitors has an electrical capacity greater than 15 F and/or a nominal voltage greater than 700V.

17. A land vehicle for launching a drone equipped with one or more turbojet or turboprop engines, the land vehicle being provided with a catapult system for the drone, comprising a launch ramp and a mobile assembly for supporting the drone, the mobile assembly being, in a launch position of the catapult system, guided by the launch ramp in a launch direction along a linear path of the launch ramp, wherein the launch ramp comprises a plurality of articulated sections, at least some of which are movable between the launch position, in which the sections are aligned and the launch ramp has a length of more than 8 meters, and a transport position, in which the sections are side by side.

18. The land vehicle of claim 17, wherein the catapult system comprises at least a permanent magnet synchronous linear motor comprising a stator-shaped inductor comprising windings or electromagnets disposed along the linear path, and an armature comprising permanent magnets disposed on the mobile assembly.

19. The land vehicle of claim 17, wherein the articulated sections are articulated in pairs with parallel pivot axes.

20. The land vehicle of claim 19, wherein the pivot axes are vertical in the transport position and when the launch ramp is moved between the transport position to the launch position.

21. A land vehicle for launching a drone equipped with one or more turbojet or turboprop engines, the land launch vehicle comprising a body and being provided with a catapult system comprising a launch ramp which, in a launch position, has a front end portion which projects beyond a front end of the body of the vehicle, wherein the land vehicle is equipped with a removable balancing running gear which is movable between a storage position and a launch position, the balancing running gear in the launch position being on ground, at a distance in front of the front end of the body
